(19) United States
(12) Patent Application Publication
(10) Pub. No.: US 2024/0283635 A1
(43) Pub. Date: Aug. 22, 2024

(54) COMMUNICATION SYSTEM, USER TERMINAL, COMMUNICATION METHOD, AND COMMUNICATION PROGRAM

(71) Applicant: NIPPON TELEGRAPH AND TELEPHONE CORPORATION, Tokyo (JP)

(72) Inventors: Hiroki ITO, Musashino-shi, Tokyo (JP); Shinichi HIRATA, Musashino-shi, Tokyo (JP); Hideo MORI, Musashino-shi, Tokyo (JP); Takeo NAGASHIMA, Musashino-shi, Tokyo (JP)

(73) Assignee: NIPPON TELEGRAPH AND TELEPHONE CORPORATION, Tokyo (JP)

(21) Appl. No.: 18/567,785

(22) PCT Filed: Jun. 10, 2021
(86) PCT No.: PCT/JP2021/022219

§ 371 Date: Dec. 7, 2023

(51) Int. Cl. H04L 9/08

(52) U.S. Cl. CPC H04L 9/0825

(57) ABSTRACT

A communication system includes a user terminal that transmits and receives a message, and a server device that manages a public key and a private key, wherein the user terminal includes first processing circuitry configured to, when transmitting the message to another user terminal, acquire a public key corresponding to identification information about a recipient of the message, and encrypt the message or a file attached to the message, using the acquired public key, transmit, to the another user terminal, the message encrypted or the file attached to the message, when receiving the message from the another user terminal, request the server device to provide a private key for decrypting the message or the file attached to the message, and receive the private key from the server device, and decrypt the message or the file attached to the message, using the private key received.

### TECHNICAL FIELD

The present invention relates to a communication system, a user terminal, a communication method, and a communication program.

### BACKGROUND ART

There is a known conventional technology for performing secure transmission and reception e-mail between two areas via the Internet in a case where e-mail is used as one form of message transmission and reception (see Patent Literature 1, for example).

By such a technology, for example, in a case where the destination domain (area B) in the destination address of mail transmitted from a user terminal is a specific encryption target domain, the mail server at an area A encrypts the body of the mail (including an attached file or the like) using the public key corresponding to the destination domain, and sends the mail to the destination domain (area B). Meanwhile, the mail server at the area B checks whether the received mail is encrypted. In a case where the mail is encrypted, the mail server decrypts the mail using a private key stored in the mail server, and delivers the mail to the user terminal.

Also, a public key encryption method is normally used to encrypt and decrypt a message or an attached file or the like between a message sender and a message recipient, and conceal communication in the path in between. To implement a general public key encryption method, the message sender needs to obtain the public key necessary for sharing a key pair, or creating an encrypted message or an attached file that can be decrypted only by the message recipient, prior to encryption of the message or the attached file.

On the other hand, there is identity-based encryption (ID-based encryption, or IBE) as a method for generating a private key necessary for encryption and decryption, using a known identifier as the public key. The ID-based encryption is one of the methods according to public key encryption technologies, and is a method for characteristically generating a private key after defining a public key in generating a key pair of the private key and the public key. Accordingly, an identifier such as a mail address, a name, or any appropriate character string designated by the person who performs decryption can be used as the public key.

In the ID-based encryption, the sender encrypts a message or a file attached to the mail using the identifier acquired from the key generator, and transmits the encrypted message or file to the recipient, as in generation and decryption of encrypted text using conventional public key encryption. The recipient decrypts the encrypted message or file attached to the mail, using the private key acquired from the key generator.

Further, there is attribute-based encryption (ABE) as a method for encrypting and decrypting attributes (such as the name of the division/section to which the recipient belongs, the official position, and the decryption-allowed duration) related as the recipient, as conditions for allowing decryption.

In the attribute-based encryption, the decryption target message or a file attached to the mail is encrypted, with the policy as the conditions for decryption being included in the message or the file. The encrypted message or file is then transmitted to the recipient. Only in a case where the recipient matches the policy, can the encrypted message or the encrypted file attached to the mail be decrypted.

An example of the policy includes the identifier of the decryption-allowed user, the identifier of a decryption-allowed organization (a group of users), and a decryption-allowed duration. Also, the private key held by the recipient includes the identifier of the user and the identifier of the organization. The sender generates encrypted text in which the policy information obtained by combining these conditions is embedded in the decryption target message or a file attached to the mail, and, when the recipient decrypts the encrypted text, decryption is performed in a case where the policy information matches the policy such as the identifier embedded in the private key possessed by the recipient and the decryption timing. Since the attribute-based encryption is normally implemented to include the ID-based encryption, these two technologies will be hereinafter collectively referred to as “attribute-based encryption” in this specification.

### CITATION LIST

### Patent Literature

Patent Literature 1: Japanese Laid-open Patent Publication No. 2011-217268 A

### SUMMARY OF INVENTION

### Technical Problem

By any conventional technology, however, there are cases where simpler and safer message transmission and reception cannot be performed without key management in a user terminal.

For example, by a conventional technology, the confidentiality regarding communication between the mail server at the area A and the mail server at the area B is secured on the basis of the encryption method used for the body of mail (including an attached file or the like). However, the body of mail (including an attached file or the like) decrypted into plain text by the mail server in each area circulates as plain text in the area.

These conventional technologies have problems described below. As for the first problem, the body of mail (including an attached file or the like) is encrypted and decrypted on a mail server basis, for example. Mail and an attached file decrypted in a mail server are distributed as plain text in the closed network in the same area. In a case where there is an attack in the closed network, the contents of the decrypted mail and the attached file might be easily viewed by the attacker.

Further, as for the second problem, the recipient of mail the sender has erroneously sent to a wrong destination (mail erroneously addressed to a user at a different destination in the same domain) can check the contents of the mail, for example. As for the body of mail and an attached file downloaded into a user terminal, it is necessary to secure confidentiality of the document on the basis of the official position, the business operation, the division/section concerned, the business project concerned, and the like, and other employees who are not involved in the business requiring the document should be prohibited from viewing the body of the mail (including the attached file or the like).

Furthermore, as for the third problem, encrypted mail cannot be sent to a domain or a user at an address where the public key has not been registered in the mail server in advance. For example, in a case where secure mail transmission and reception based on a conventional technology is newly performed with a user having a mail address belonging to a domain where the public key is not registered in the mail server, the administrator of the mail server needs to exchange public keys in advance, which is troublesome.

The present invention has been made in view of the above, and aims to provide a communication system, a user terminal, a communication method, and a communication program for enabling simpler and safer message transmission and reception without advance registration of a public key.

### Solution to Problem

To solve the above problem and achieve the objective, a communication system according to the present invention is a communication system that includes: a user terminal that transmits and receives a message; and a server device that manages a public key and a private key, wherein the user terminal includes: an encryption unit that, when transmitting the message to another user terminal, acquires a public key corresponding to identification information about a recipient of the message, and encrypts the message or a file attached to the message, using the acquired public key; a transmission unit that transmits, to the another user terminal, the message encrypted by the encryption unit or the file attached to the message; a requesting unit that, when receiving the message from the another user terminal, requests the server device to provide a private key for decrypting the message or the file attached to the message, and receives the private key from the server device; and a decryption unit that decrypts the message or the file attached to the message, using the private key received by the requesting unit, and the server device includes a key generation unit that, when accepting a request for the private key from the user terminal, generates the private key corresponding to the identification information about the recipient of the message, and transmits the private key to the user terminal.

### Advantageous Effects of Invention

According to the present invention, it is possible to perform simpler and safer message transmission and reception, without advance registration of a public key.

### BRIEF DESCRIPTION OF DRAWINGS

FIG. 1 is a block diagram illustrating an example configuration of a communication system according to a first embodiment.

FIG. 2 is a sequence diagram illustrating an example flow of processing in the communication system according to the first embodiment.

FIG. 3 is a sequence diagram illustrating an example flow of processing in the communication system according to the first embodiment.

FIG. 4 is a diagram illustrating an example of an encryption policy setting screen.

FIG. 5 is a block diagram illustrating an example configuration of a communication system according to a second embodiment.

FIG. 6 is a sequence diagram illustrating an example flow of processing in the communication system according to the second embodiment.

FIG. 7 is a sequence diagram illustrating an example flow of processing in the communication system according to the second embodiment.

FIG. 8 is a block diagram illustrating an example configuration of a communication system according to a third embodiment.

FIG. 9 is a sequence diagram illustrating an example flow of processing in the communication system according to the third embodiment.

FIG. 10 is a sequence diagram illustrating an example flow of processing in the communication system according to the third embodiment.

FIG. 11 is a sequence diagram illustrating an example flow of processing in the communication system according to the third embodiment.

FIG. 12 is a block diagram illustrating an example configuration of a communication system according to a fourth embodiment.

FIG. 13 is a sequence diagram illustrating an example flow of processing in the communication system according to the fourth embodiment.

FIG. 14 is a sequence diagram illustrating an example flow of processing in the communication system according to the fourth embodiment.

FIG. 15 is a block diagram illustrating an example configuration of a communication system according to a fifth embodiment.

FIG. 16 is a sequence diagram illustrating an example flow of processing in the communication system according to the fifth embodiment.

FIG. 17 is a sequence diagram illustrating an example flow of processing in the communication system according to the fifth embodiment.

FIG. 18 is a sequence diagram illustrating an example flow of processing in the communication system according to the fifth embodiment.

FIG. 19 is a block diagram illustrating an example configuration of a communication system according to a sixth embodiment.

FIG. 20 is a sequence diagram illustrating an example flow of processing in the communication system according to the sixth embodiment.

FIG. 21 is a sequence diagram illustrating an example flow of processing in the communication system according to the sixth embodiment.

FIG. 22 is a sequence diagram illustrating an example flow of processing in the communication system according to the sixth embodiment.

FIG. 23 is a diagram illustrating a computer that executes a communication program.

### DESCRIPTION OF EMBODIMENTS

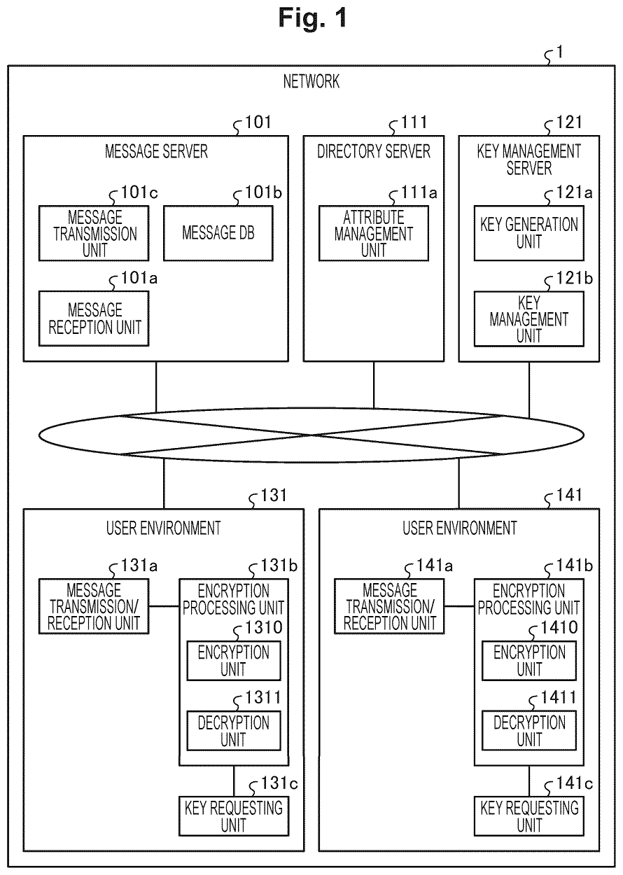

The following is a detailed description of embodiments of communication systems, user terminals, communication methods, and communication programs according to the present application, with reference to the drawings. Note that communication systems, user terminals, communication methods, and communication programs according to the present application are not limited by these embodiments.

[First Embodiment] In the description below, a configuration of a communication system according to a first embodiment and a flow of processing in the communication system are sequentially explained, and lastly, the effects of the first embodiment are explained.

[Configuration of a Communication System] First, an example configuration of a communication system according to this embodiment is described with reference to FIG. 1. FIG. 1 is a block diagram illustrating an example configuration of a communication system according to the first embodiment. Note that the configuration illustrated in FIG. 1 is merely an example, and specific configurations are not particularly limited to this configuration.

As illustrated in FIG. 1, the communication system of this embodiment includes, in a network 1, a message server 101, a directory server 111, a key management server 121, a user environment 131, and a user environment 141, and these are connected to one another in the network 1. Note that the user environments 131 and 141 may have any configuration herein, but include at least a user terminal.

The user environment 131 and the user environment 141 are assigned to individual users and transmit and receive messages to and from each other, and have the same configurations accordingly. However, the description below is based primarily on the assumption of an example case where a message is transmitted from the user environment 131 to the user environment 141.

The message server 101 includes: a message reception unit 101a that receives a message transmitted from a message transmission/reception unit 131a of the user environment 131: a message DB 101b that temporarily stores the message; and a message transmission unit 101c that identifies the message addressed to a user on the basis of a message reception request from the user environment 141 being used by the user at the destination of the message, and transmits the message to the user environment 141.

The directory server 111 includes an attribute management unit 111a that manages attributes related to users present in the network 1, and provides the attributes in response to requests for other functions. The attributes in this case include an identifier for identifying a user such as a mail address or the account name at the time of login, affiliation information indicating a group to which the user belongs, an official position, authority, and the like, and general attribute information associated with the individual such as the name necessary for the user to use not only this system in the network but also any system connected in the network.

The key management server 121 includes: a key generation unit 121a that generates a key pair according to a public key encryption scheme necessary for encrypting and decrypting a message distributed via the message server 101; and a key management unit 121b that manages the key pair.

The user environment 131 includes: a message transmission/reception unit 131a that distributes a message via the message server 101; an encryption processing unit 131b necessary for encrypting and decrypting the message or a file attached to the message; and a key requesting unit 131c that manages a public key or a private key necessary for the encryption process. Note that the user environment 141 has the same configuration as the user environment 131, and therefore, explanation thereof is not made herein.

The encryption processing unit 131b includes an encryption unit 1310 and a decryption unit 1311. In a case where a message is transmitted to another user terminal (the user environment 141), the encryption unit 1310 acquires a public key corresponding to the identification information about the recipient of the message, and, using the acquired public key, encrypts the message or a file attached to the message. For example, the encryption unit 1310 uses the conventional ID-based encryption, to encrypt the message or the file attached to the message, with an identifier such as a mail address or the name of the recipient being used as the public key (see Reference Literature 1, for example).

Reference Literature 1: Kobayashi, Yamamoto, Suzuki, and Hirata, “Applications of ID-Based Encryption, and Public Key Encryption with Keyword Search”, NTT Technical Journal, February 2010

Also, for example, the encryption unit 1310 may encrypt the message or the file attached to the message, with policy information included in the message or the file, the policy information indicating conditions for allowing decryption. For example, the encryption unit 1310 may encrypt the decryption target message or a file attached to the mail including a decryption condition policy, using a conventional attribute-based encryption technique (see Reference Literature 2, for example).

Reference Literature 2: Abe, Tokunaga, Mehdi, Nishimaki, and Kusagawa, “The Forefront of Cryptology Studies for Coping with Changes in Computation Environments”, NTT Technical Journal, February 2020

The decryption unit 1311 decrypts the message or the file attached to the message, using a private key received by the key requesting unit 131c. Also, the decryption unit 1311 may perform decryption in a case where the identification information embedded in the private key possessed by the recipient, the decryption timing, and the like match the policy. In this case, the private key includes the identifier of the user and the identifier of the organization, for example.

The message transmission/reception unit 131a transmits the message obtained by the encryption unit 1310 encrypting the message or the file attached to the message, to another user terminal (the user environment 141).

In a case where a message is received from another user terminal (the user environment 141), the key requesting unit 131c requests the key management server 121 for the private key for decrypting the message or the file attached to the message, and receives the private key from the key management server 121.

The key management server 121 includes the key generation unit 121a and the key management unit 121b. When accepting a request for a private key from the user environment 131 or 141, the key generation unit 121a generates the private key corresponding to the identification information of the recipient of the message, and transmits the private key to the user environment 131 or 141.

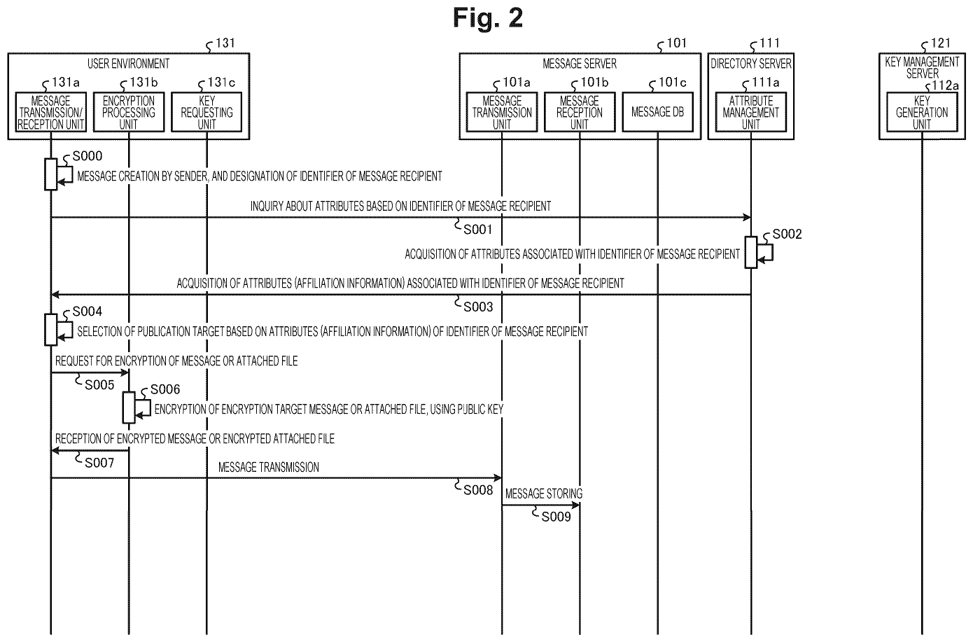

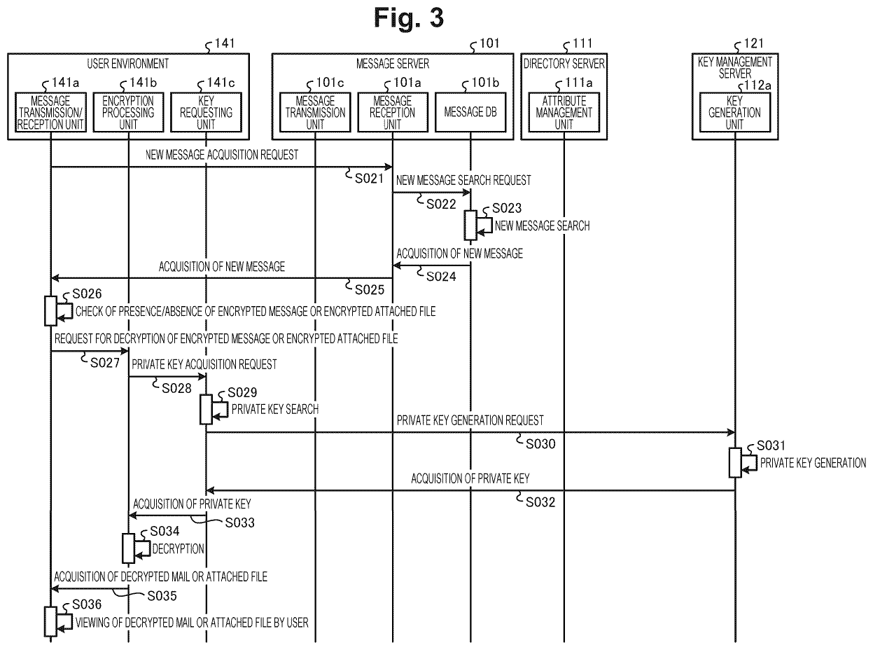

The key management unit 121b stores both the public key and the private key corresponding to the message recipient. For example, in a case where a request for a private key is received from the user environment 131 or 141, the key management unit 121b transmits the private key to the user environment 131 or 141 when the requested private key is stored therein, and transmits a generated private key to the user environment 131 or 141 after requesting the key generation unit 121a to generate the private key when the requested private key is not stored therein.

[Processing Procedures in the Communication System] Next, an example of the processing procedures in a communication process to be performed by the communication system is described with reference to FIGS. 2 and 3. FIGS. 2 and 3 are sequence diagrams illustrating an example flow of processing in the communication system according to the first embodiment.

As illustrated in FIGS. 2 and 3, a message sender creates a message addressed to the recipient of the message, using the user environment 131. The body of the message or a file attached to the message is intended to prevent a third party other than the sender of the message or the recipient of the message from viewing. The message sender designates the message or the file attached to the message, and the identifier of the message recipient (a mail address of the recipient, for example) (S000).

The message transmission/reception unit 131a of the user environment 131 requests the directory server 111 for affiliation information indicating the group to which the message recipient belongs, the official position, the authority, and the like, on the basis of the identifier of the message recipient (S001). The directory server 111 acquires the affiliation information related to the message recipient from the attribute management unit 111a on the basis of the identifier (S002), and supplies the affiliation information to the message transmission/reception unit 131a of the user environment 131 (S003).

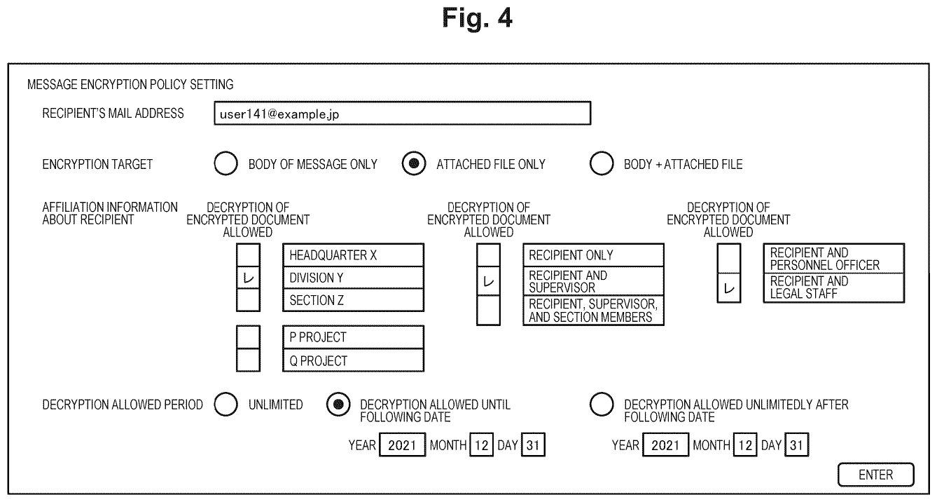

On the basis of the affiliation information, the message transmission/reception unit 131a of the user environment 131 presents a message encryption policy setting screen illustrated in FIG. 4 to the message sender, and causes the message sender to input the encryption policy (S004). FIG. 4 is a diagram illustrating an example of the encryption policy setting screen.

On the basis of the encryption policy, the message transmission/reception unit 131a of the user environment 131 requests the encryption processing unit 131b to encrypt the message or the attached file (S005). The encryption processing unit 131b then encrypts the message or the attached file, using the public key and the encryption policy, the identifier being the public key (S006). Subsequently, the encryption processing unit 131b transmits the encrypted message or the encrypted attached file to the message transmission/reception unit 131a (S007).

The message transmission/reception unit 131a then transmits the encrypted message or the encrypted attached file to the message transmission unit 101c of the message server 101 (S008). The message transmission unit 101c stores the message (S009).

Subsequently, the message recipient requests the message server 101 to acquire a new message, using the user environment 141 (S021). The message reception unit 101a of the message server 101 then requests the message DB 101b to search for a new message addressed to the message recipient (S022). The message DB 101b then searches for a new message addressed to the message recipient (S023), and replies with the new message to the message reception unit 101a (S024). The message reception unit 101a replies with the new message to the message transmission/reception unit 141a of the user environment 141 (S025).

The message transmission/reception unit 141a of the user environment 141 checks the presence/absence of an encrypted message or an encrypted attached file in the acquired new message (S026), and, if the new message includes an encrypted message or an encrypted attached file, requests the encryption processing unit 141b for the identifier of the message recipient used in the encryption of the encrypted message or the encrypted attached file, and for decryption of the encrypted message or the encrypted attached file (S027).

The encryption processing unit 141b of the user environment 141 requests the key requesting unit 141c for the private key necessary for decrypting the encrypted message or the encrypted attached file (S028). The key requesting unit 141c searches for the private key (S029), and, if the private key is not stored in the key storage area, requests the key management server 121 to generate the private key corresponding to the identifier (S030).

The key management server 121 generates the private key corresponding to the identifier at the key generation unit 121a (S031), and replies with the private key to the key requesting unit 141c of the user environment 141 (S032). The encryption processing unit 141b of the user environment 141 acquires the private key from the key storage area of the key requesting unit 141c (S033), and decrypts the encrypted message or the encrypted attached file (S034).

The message transmission/reception unit 141a of the user environment 141 then acquires the decrypted message or the decrypted attached file from the encryption processing unit 141b (S035), and causes the message recipient to view the decrypted message or the decrypted attached file (S036).

[Effects of the First Embodiment] As described above, in the communication system according to the first embodiment, a user terminal encrypts mail using the public key corresponding to the user identifier at the time of transmission of the mail, and acquires the corresponding private key from the key management unit 121b at the time of reception of the mail, to decrypt the mail. Thus, it is possible to perform simpler and safer message transmission and reception, without advance registration of the public key. For example, in the communication system according to the first embodiment, it is possible to achieve a secure message transmission/reception function capable of encrypting and transmitting/receiving the body of mail or a file attached thereto between the user environment 161 of the sender and the user environment 162 of the reception, the message transmission/reception function being associated with the user account of the recipient, and attribute information such as the name of the organization to which the user account belongs and the official position.

[Second Embodiment] In the first embodiment described above, a case where communication is performed with a single mail server and a single directory server on the assumption of communication in a single organization and in a single network has been described. However, the present invention is not limited to this, and communication may be performed with a system on the assumption of cooperation between multiple organizations and between multiple networks. In the description below, a communication system based on the assumption of cooperation between multiple organizations and between multiple networks is explained as a second embodiment. The second embodiment described below concerns a case where a key management server exists in the transmission-side network, and the recipient on the reception-side network side downloads a private key from a website prepared on the transmission-side network side. Note that explanation of the components and processes that are the same as those of the first embodiment is not made herein.

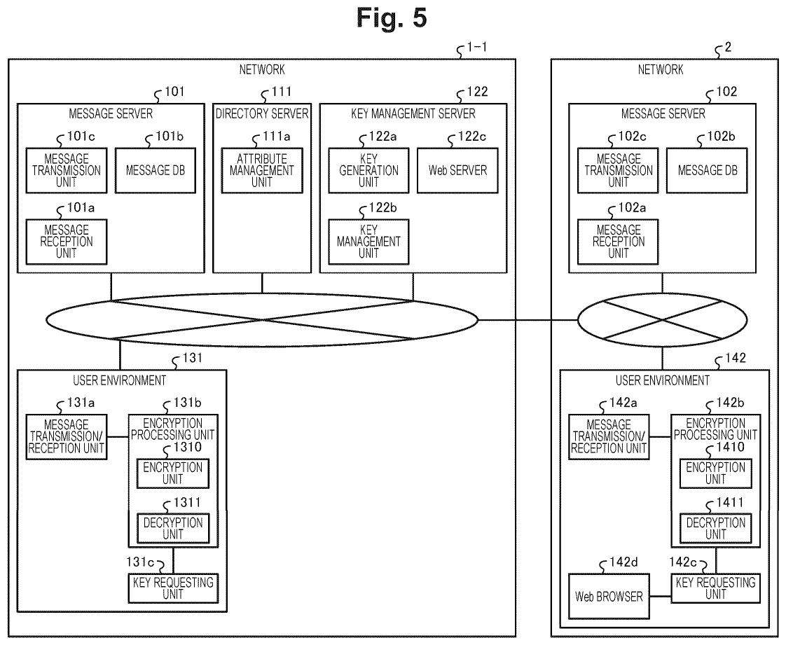

FIG. 5 is a block diagram illustrating an example configuration of a communication system according to the second embodiment. As illustrated in FIG. 5, the communication system of the second embodiment includes, in a network 1-1, a message server 101, a user environment 131, a directory server 111, and a key management server 122, and these are connected to one another in the network 1-1. The communication system also includes a message server 102 and a user environment 142 in a network 2, and these are connected to each other in the network 2.

In the communication system according to the second embodiment, the key management server 121 is present in the network 1-1, and the recipient present in the network 2 downloads the private key from the key management server 122 prepared in the network 1-1.

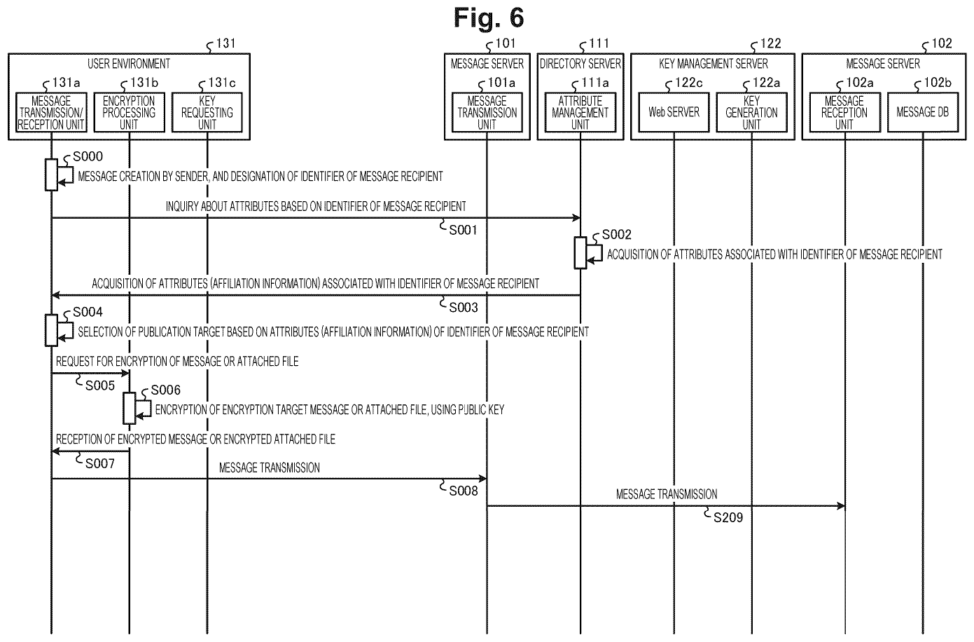

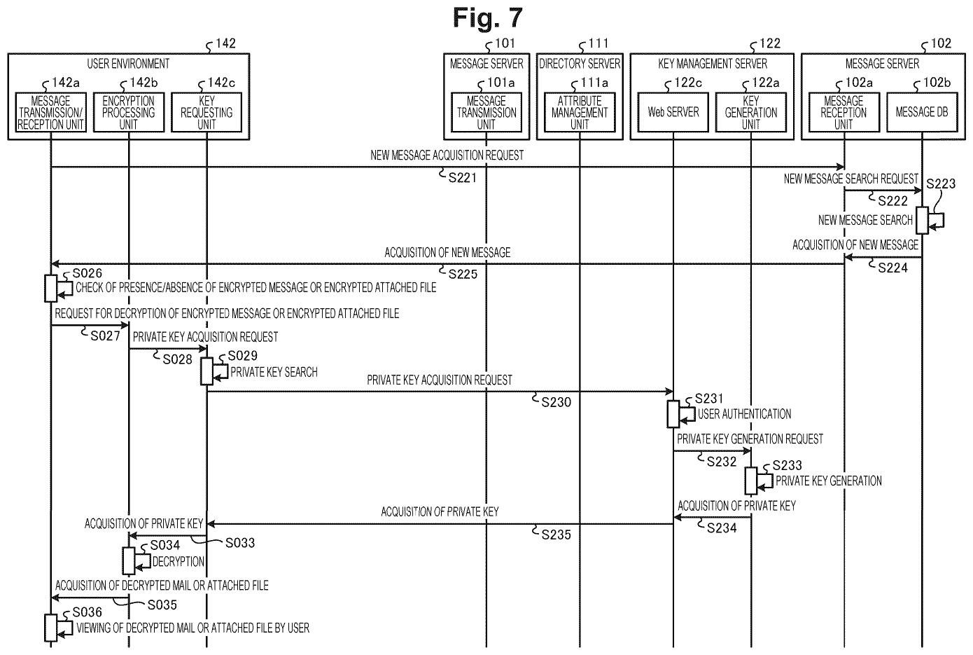

The key management server 122 includes a key generation unit 122a, a key management unit 122b, and a web server 122c. The web server 122c receives a request for the private key from the key requesting unit 142c via a website.

[Processing Procedures in the Communication System] Next, an example of the processing procedures in a communication process to be performed by the communication system is described with reference to FIGS. 6 and 7. FIGS. 6 and 7 are sequence diagrams illustrating an example flow of processing in the communication system according to the second embodiment.

As illustrated in FIGS. 6 and 7, after an encryption process is performed in the user environment 131 (S000 to S008) as in FIG. 2, the message transmission unit 101c transmits the message to a message DB 102b of the message server 102 (S209).

Subsequently, the message recipient requests the message server 102 to acquire a new message, using the user environment 142 (S221). A message reception unit 102a of the message server 102 then requests the message DB 102b to search for a new message addressed to the message recipient (S222). The message DB 102b then searches for a new message addressed to the message recipient (S223), and replies with the new message to the message reception unit 102a (S224). The message reception unit 102a replies with the new message to a message transmission/reception unit 142a of the user environment 142 (S225).

The message transmission/reception unit 142a of the user environment 142 checks the presence/absence of an encrypted message or an encrypted attached file in the acquired new message (S026), and, if the new message includes an encrypted message or an encrypted attached file, requests an encryption processing unit 142b for the identifier of the message recipient used in the encryption of the encrypted message or the encrypted attached file, and for decryption of the encrypted message or the encrypted attached file (S027).

The encryption processing unit 142b of the user environment 142 requests a key requesting unit 142c for the private key necessary for decrypting the encrypted message or the encrypted attached file (S028). The key requesting unit 141c searches for the private key (S029), and, if the private key is not stored in the key storage area, requests the key management server 122 to generate the private key corresponding to the identifier (S230).

The web server 122c of the key management server 122 performs user authentication (S231), and requests the key generation unit 122a to generate the private key (S232). The key generation unit 122a of the key management server 122 then generates the private key corresponding to the identifier (S233), and replies with the private key to the web server 122c (S234). The web server 122c then replies with the private key to the key requesting unit 142c of the user environment 142 (S235). The encryption processing unit 141b of the user environment 141 acquires the private key from the key storage area of the key requesting unit 141c (S033), and decrypts the encrypted message or the encrypted attached file (S034).

The message transmission/reception unit 141a of the user environment 141 then acquires the decrypted message or the decrypted attached file from the encryption processing unit 141b (S035), and causes the message recipient to view the decrypted message or the decrypted attached file (S036).

[Third Embodiment] The third embodiment described below concerns a case where the key management server of the reception-side network receives the private key of the recipient from the key management server of the transmission-side network, and a user of the reception-side network receives the private key from a key management system of the reception-side organization. Note that explanation of the components and the processes that are the same as those of the above embodiments is not made herein.

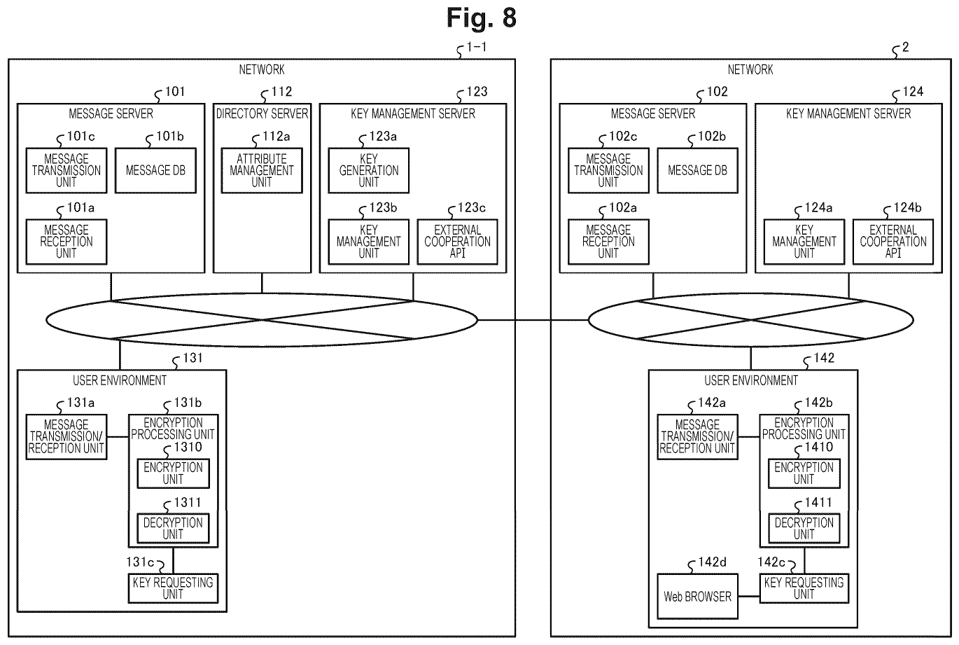

FIG. 8 is a block diagram illustrating an example configuration of a communication system according to the third embodiment. As illustrated in FIG. 8, in the communication system according to the third embodiment, a key management server 124 is provided in a reception-side network 2, and a key management server 123 is provided in a transmission-side network 1-1. The key management server 124 in the network 2 downloads a private key from the key management server 123 prepared in the network 1-1.

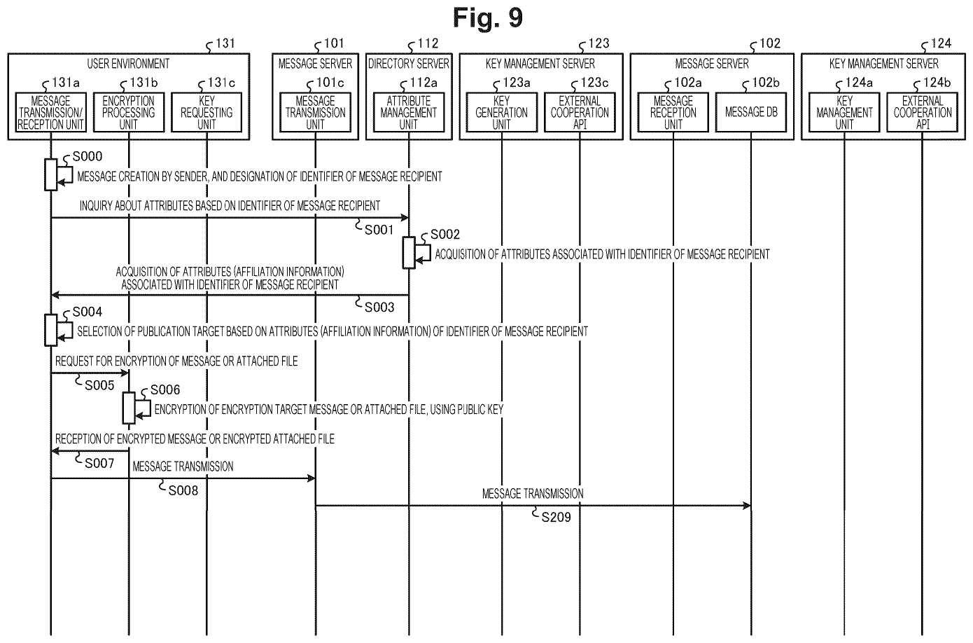

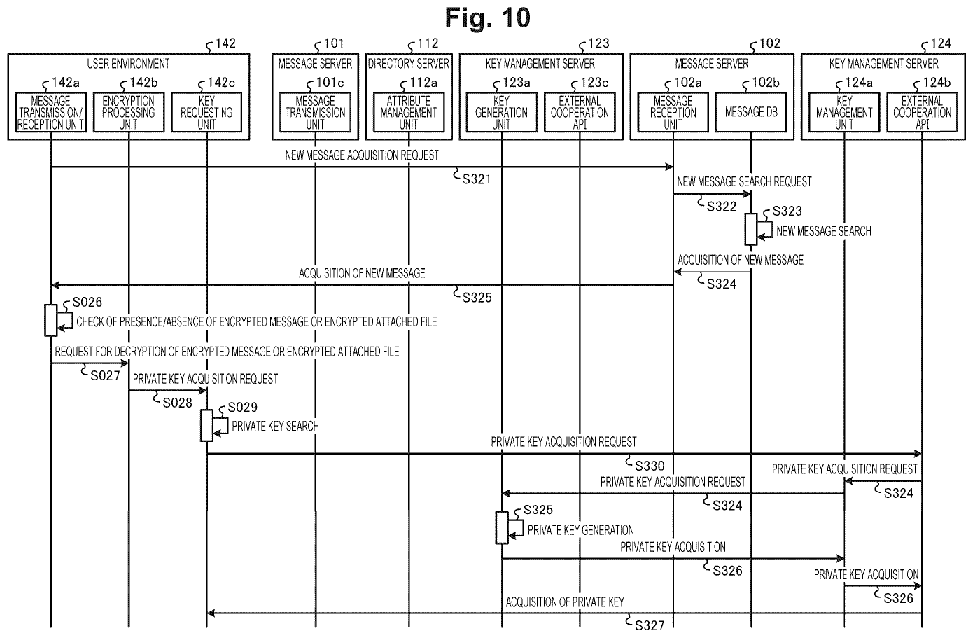

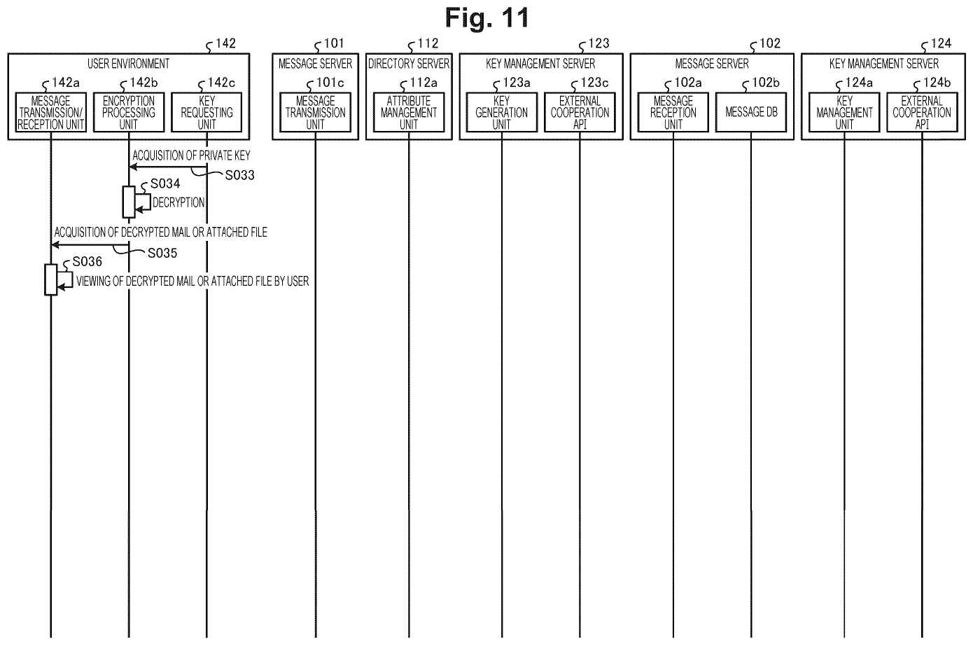

The key management server 123 includes a key generation unit 123a, a key management unit 123b, and an external cooperation API 123c. The external cooperation API 123c accepts a private key acquisition request from the key management server 124. Meanwhile, the key management server 124 includes a key management unit 124a and an external cooperation API 124b. The external cooperation API 124b accepts a private key acquisition request from the user environment 142, and downloads the private key from the key management server 123.

[Processing Procedures in the Communication System] Next, an example of the processing procedures in a communication process to be performed by the communication system is described with reference to FIGS. 9 to 11. FIGS. 9 to 11 are sequence diagrams illustrating an example flow of processing in the communication system according to the third embodiment.

As illustrated in FIGS. 9 to 11, after an encryption process is performed in the user environment 131 (S000 to S008) as in FIG. 2, the message transmission unit 101c transmits the message to the message DB 102b of the message server 102 (S209).

Subsequently, the message recipient requests the message server 102 to acquire a new message, using the user environment 142 (S321). The message reception unit 102a of the message server 102 then requests the message DB 102b to search for a new message addressed to the message recipient (S322). The message DB 102b then searches for a new message addressed to the message recipient (S323), and replies with the new message to the message reception unit 102a (S324). The message reception unit 102a replies with the new message to the message transmission/reception unit 142a of the user environment 142 (S325).

The message transmission/reception unit 142a of the user environment 142 checks the presence/absence of an encrypted message or an encrypted attached file in the acquired new message (S026), and, if the new message includes an encrypted message or an encrypted attached file, requests an encryption processing unit 142b for the identifier of the message recipient used in the encryption of the encrypted message or the encrypted attached file, and for decryption of the encrypted message or the encrypted attached file (S027).

The encryption processing unit 142b of the user environment 142 requests a key requesting unit 142c for the private key necessary for decrypting the encrypted message or the encrypted attached file (S028). The key requesting unit 141c searches for the private key (S029), and, if the private key is not stored in the key storage area, requests the key management server 124 to generate the private key corresponding to the identifier (S330).

The external cooperation API 124b of the key management server 124 requests the key generation unit 123a to acquire the private key, via the key management unit 124a (S324). The key generation unit 123a of the key management server 123 then generates the private key corresponding to the identifier (S325), and replies with the private key to the external cooperation API 124b (S326). The external cooperation API 124b then replies with the private key to the key requesting unit 142c of the user environment 142 (S327). The encryption processing unit 142b of the user environment 142 acquires the private key from the key storage area of the key requesting unit 142c (S033), and decrypts the encrypted message or the encrypted attached file (S034).

The message transmission/reception unit 142a of the user environment 142 then acquires the decrypted message or the decrypted attached file from the encryption processing unit 142b (S035), and causes the message recipient to view the decrypted message or the decrypted attached file (S036).

[Fourth embodiment] The fourth embodiment described below concerns a case where a key management server is present in the reception-side network, and the key management server generates and distributes a private key. Note that explanation of the components and the processes that are the same as those of the above embodiments is not made herein.

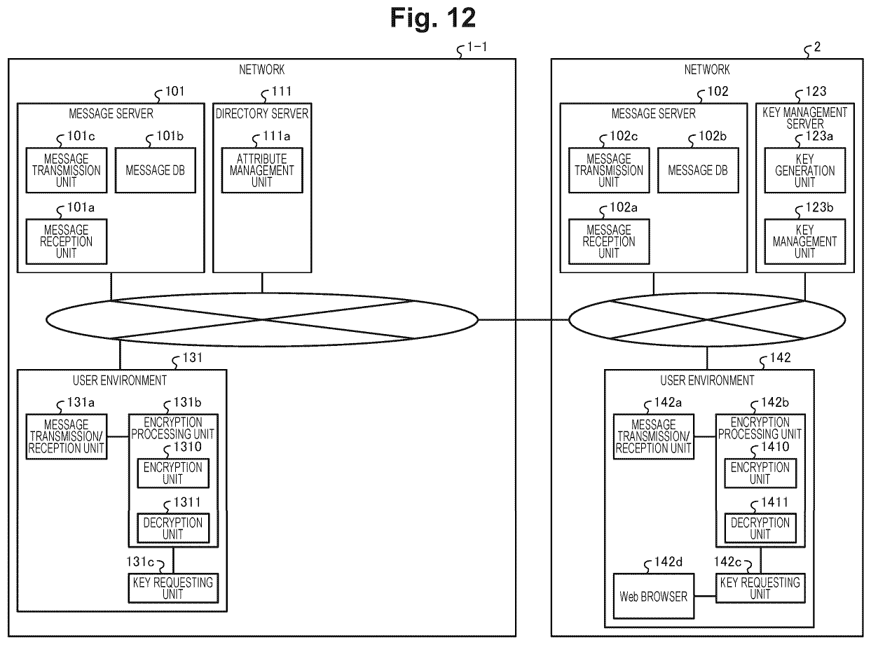

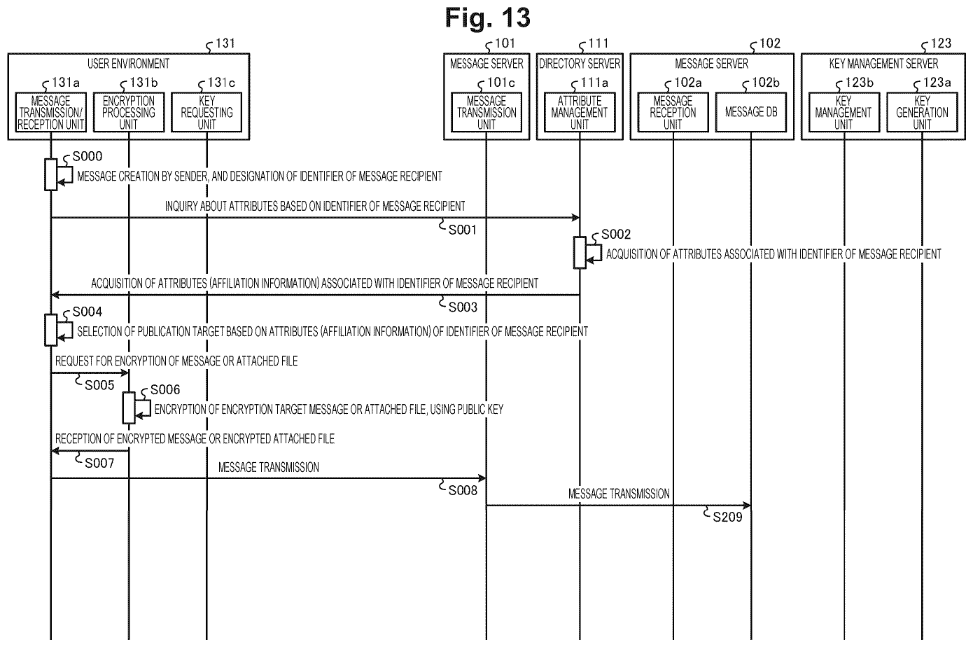

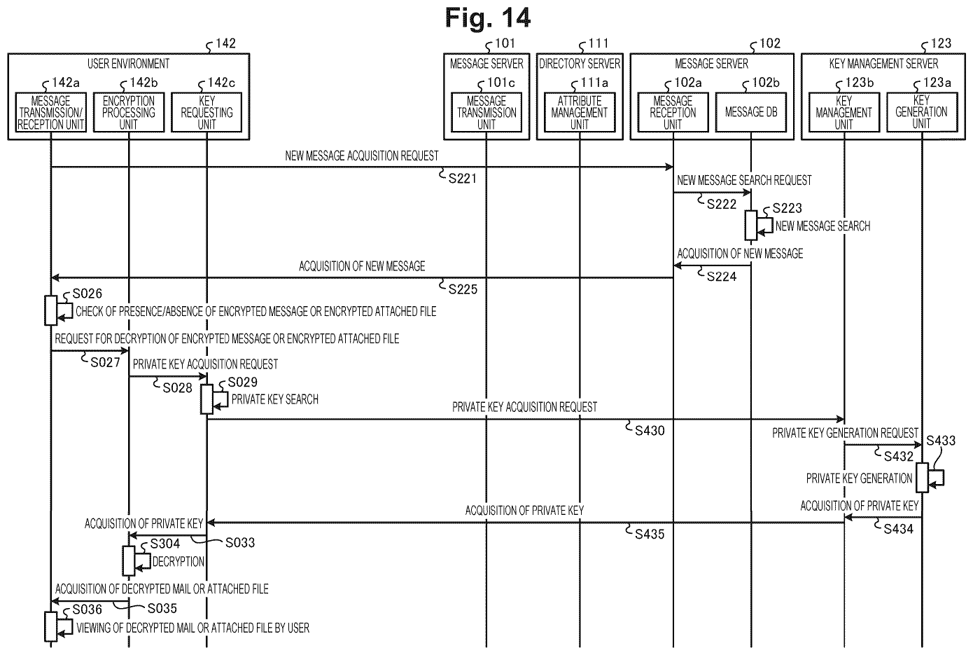

FIG. 12 is a block diagram illustrating an example configuration of a communication system according to the fourth embodiment. In the communication system according to the fourth embodiment, a user in the reception-side organization receives a private key from a key management system of the reception-side organization. As illustrated in FIG. 12, a key management server 123 is provided only in the reception-side network 2. The key management server 123 includes a key generation unit 123a and a key management unit 123b.

[Processing Procedures in the Communication System] Next, an example of the processing procedures in a communication process to be performed by the communication system is described with reference to FIGS. 13 and 14. FIGS. 13 and 14 are sequence diagrams illustrating an example flow of processing in the communication system according to the fourth embodiment.

As illustrated in FIGS. 13 and 14, after an encryption process is performed in the user environment 131 (S000 to S008) as in FIG. 2, the message transmission unit 101c transmits the message to the message DB 102b of the message server 102 (S209).

Subsequently, the message recipient requests the message server 102 to acquire a new message, using the user environment 142 (S221). A message reception unit 102a of the message server 102 then requests the message DB 102b to search for a new message addressed to the message recipient (S222). The message DB 102b then searches for a new message addressed to the message recipient (S223), and replies with the new message to the message reception unit 102a (S224). The message reception unit 102a replies with the new message to a message transmission/reception unit 142a of the user environment 142 (S225).

The message transmission/reception unit 142a of the user environment 142 checks the presence/absence of an encrypted message or an encrypted attached file in the acquired new message (S026), and, if the new message includes an encrypted message or an encrypted attached file, requests an encryption processing unit 142b for the identifier of the message recipient used in the encryption of the encrypted message or the encrypted attached file, and for decryption of the encrypted message or the encrypted attached file (S027).

The encryption processing unit 142b of the user environment 142 requests a key requesting unit 142c for the private key necessary for decrypting the encrypted message or the encrypted attached file (S028). The key requesting unit 141c searches for the private key (S029), and, if the private key is not stored in the key storage area, requests the key management server 123 to generate the private key corresponding to the identifier (S430).

The key management unit 123b of the key management server 123 requests the key generation unit 123a to generate the private key (S432). The key generation unit 123a of the key management server 123 then generates the private key corresponding to the identifier (S433), and replies with the private key to the web server 122c (S434). The key management unit 123b then replies with the private key to the key requesting unit 142c of the user environment 142 (S435). The encryption processing unit 141b of the user environment 141 acquires the private key from the key storage area of the key requesting unit 141c (S033), and decrypts the encrypted message or the encrypted attached file (S304).

The message transmission/reception unit 141a of the user environment 141 then acquires the decrypted message or the decrypted attached file from the encryption processing unit 141b (S035), and causes the message recipient to view the decrypted message or the decrypted attached file (S036).

[Fifth Embodiment] In the fifth embodiment described below, there is a neutral service for key management, and a private key generated by a key management function on the transmission side is managed by the key management service.

A case where the key management service transmits the private key of the recipient in response to a request (API communication) from the reception side is now described. Note that explanation of the components and the processes that are the same as those of the above embodiments is not made herein.

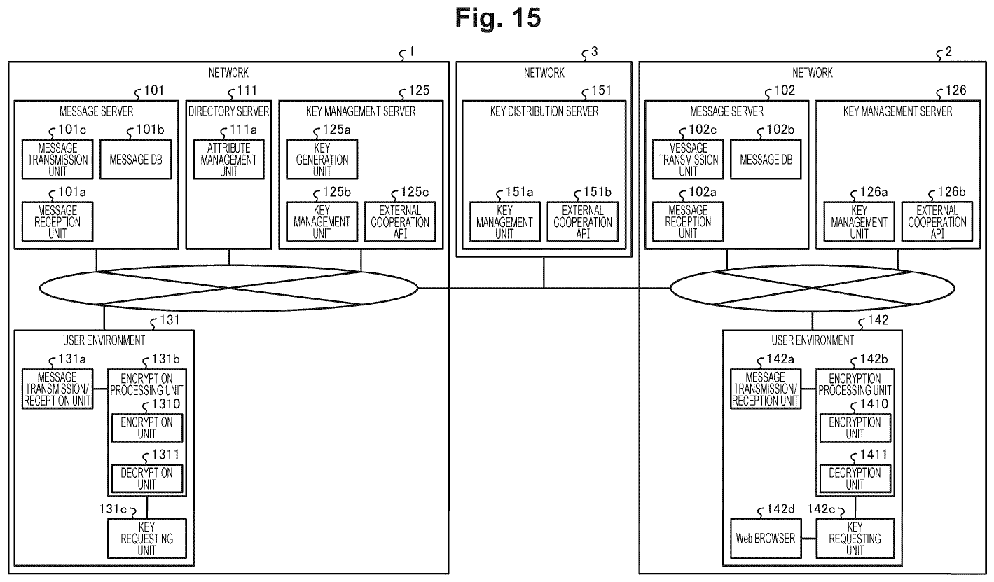

FIG. 15 is a block diagram illustrating an example configuration of a communication system according to the fifth embodiment. As illustrated in FIG. 15, the communication system according to the fifth embodiment differs from the example illustrated in FIG. 8 in that a key distribution server 151 is provided in a network 3. The key distribution server 151 includes a key management unit 151a and an external cooperation API 151b.

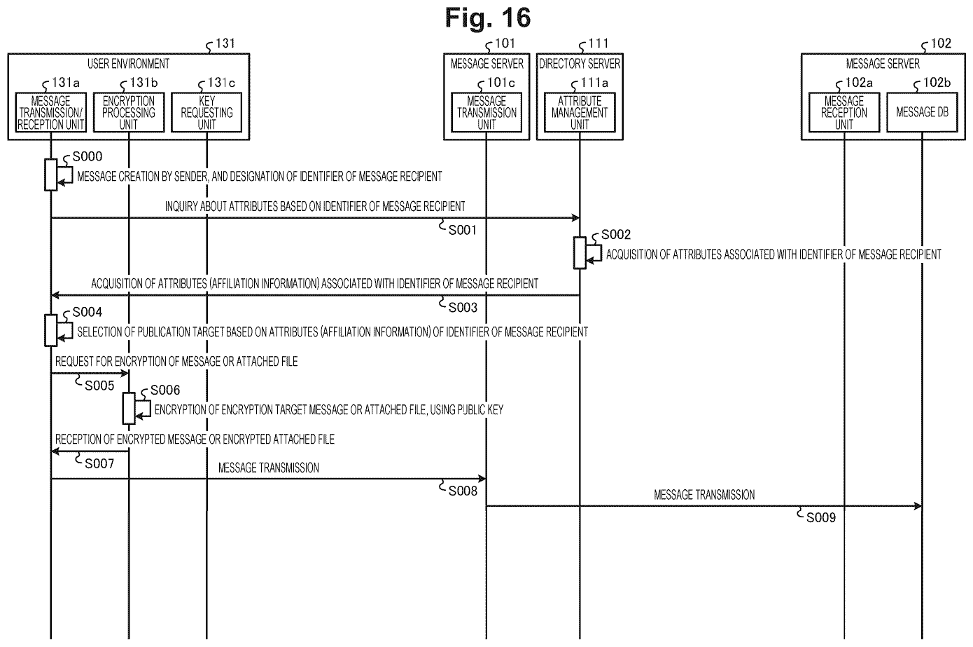

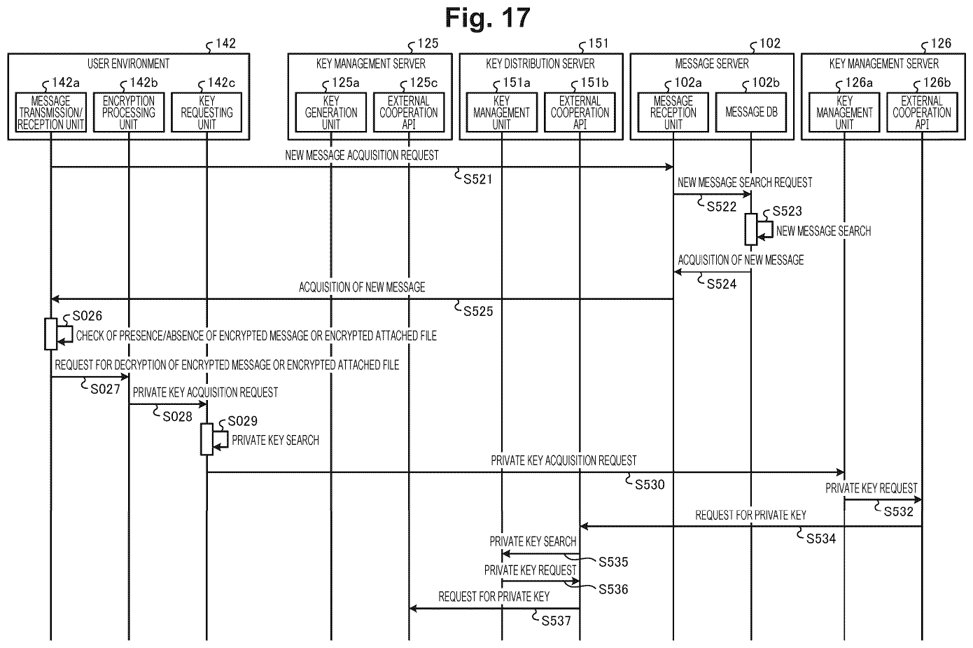

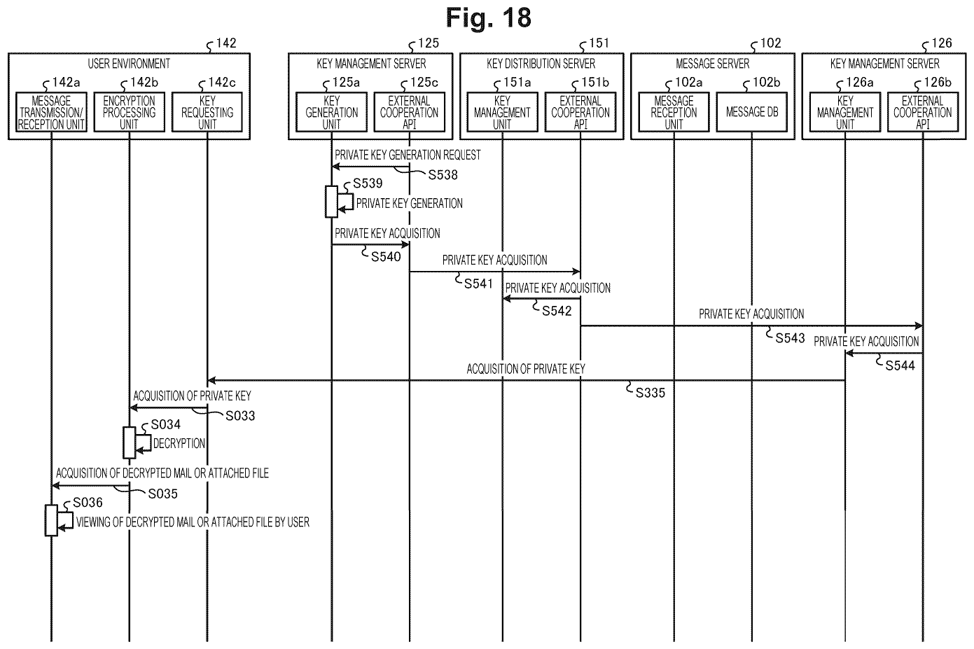

The key distribution server 151 provides a neutral service for key management. The key management unit 151a of the key distribution server 151 manages the private key generated by the key management function on the transmission side. The external cooperation API 151b transmits the private key of the recipient, in response to a request (API communication) from the reception side.

[Processing Procedures in the Communication System] Next, an example of the processing procedures in a communication process to be performed by the communication system is described with reference to FIGS. 16 to 18. FIGS. 16 to 18 are sequence diagrams illustrating an example flow of processing in the communication system according to the fifth embodiment.

As illustrated in FIGS. 16 to 18, after an encryption process is performed in the user environment 131 (S000 to S008) as in FIG. 2, the message transmission unit 101c transmits the message to the message DB 102b of the message server 102 (S009).

Subsequently, the message recipient requests the message server 102 to acquire a new message, using the user environment 142 (S521). The message reception unit 102a of the message server 102 then requests the message DB 102b to search for a new message addressed to the message recipient (S522). The message DB 102b then searches for a new message addressed to the message recipient (S523), and replies with the new message to the message reception unit 102a (S524). The message reception unit 102a replies with the new message to the message transmission/reception unit 142a of the user environment 142 (S525).

The message transmission/reception unit 142a of the user environment 142 checks the presence/absence of an encrypted message or an encrypted attached file in the acquired new message (S026), and, if the new message includes an encrypted message or an encrypted attached file, requests an encryption processing unit 142b for the identifier of the message recipient used in the encryption of the encrypted message or the encrypted attached file, and for decryption of the encrypted message or the encrypted attached file (S027).

The encryption processing unit 142b of the user environment 142 requests a key requesting unit 142c for the private key necessary for decrypting the encrypted message or the encrypted attached file (S028). The key requesting unit 141c searches for the private key (S029), and, if the private key is not stored in the key storage area, requests a key management server 126 to generate the private key corresponding to the identifier (S530). A key management unit 126a of the key management server 126 requests the private key from an external cooperation API 126b (S532).

The external cooperation API 126b of the key management server 126 requests the private key from the external cooperation API 151b of the key distribution server 151 (S534). The external cooperation API 151b of the key distribution server 151 then causes the key management unit 151a to search for the private key (S535). If the private key is not stored in its own key storage area, the key management unit 151a makes a private key request to the external cooperation API 151b (S536).

The external cooperation API 151b then makes a private key request to an external cooperation API 125b of a key management server 125 (S537). The external cooperation API 125b requests a key generation unit 125a to generate the private key (S538). The key generation unit 125a then generates the private key corresponding to the identifier (S539), and replies with the private key to the external cooperation API 125b (S540). The external cooperation API 125b then replies with the private key to the external cooperation API 151b of the key distribution server 151 (S541).

Subsequently, the external cooperation API 151b registers the private key in the key management unit 151a (S542). The external cooperation API 151b then replies with the private key to the external cooperation API 126b of the key management server 126 (S543). Subsequently, the key management unit 126a acquires the private key from the external cooperation API 126b (S544).

The key management unit 126a then replies with the private key to the key requesting unit 142c of the user environment 142 (S335). The encryption processing unit 142b of the user environment 142 acquires the private key from the key storage area of the key requesting unit 142c (S033), and decrypts the encrypted message or the encrypted attached file (S034).

The message transmission/reception unit 142a of the user environment 142 then acquires the decrypted message or the decrypted attached file from the encryption processing unit 142b (S035), and causes the message recipient to view the decrypted message or the decrypted attached file (S036).

[Sixth Embodiment] In the sixth embodiment described below, there are neutral services for key management, and the services include a key generation service and a key management service. A case where the key management service transmits the private key of the recipient in response to a request (API communication) from the reception side is now described. Note that explanation of the components and the processes that are the same as those of the above embodiments is not made herein.

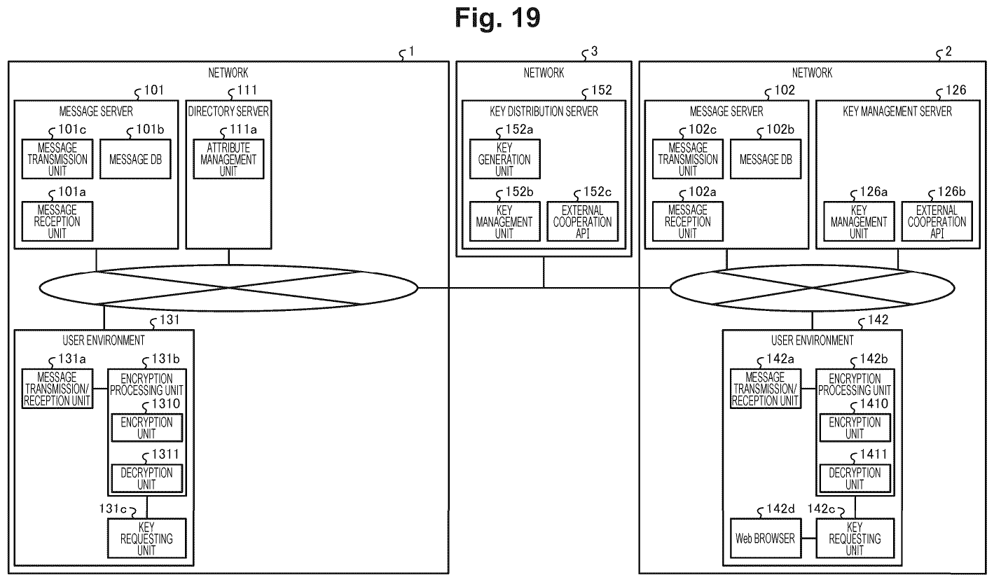

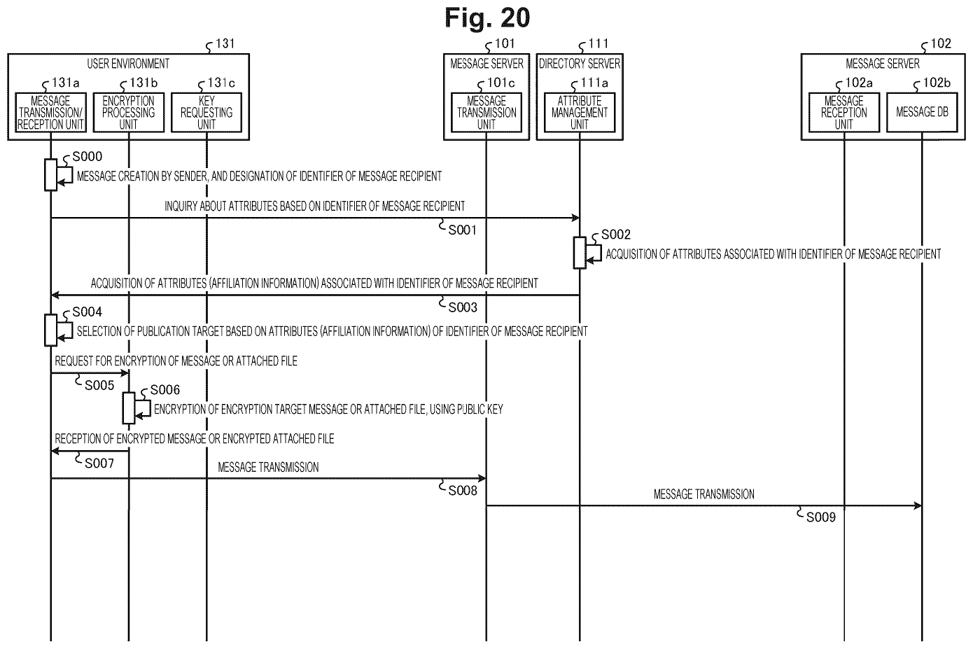

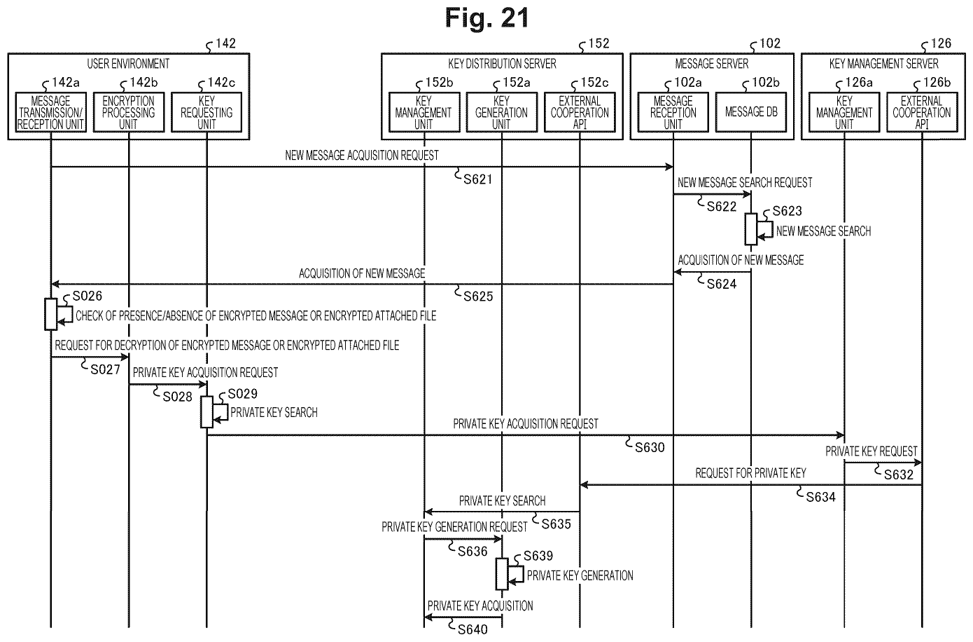

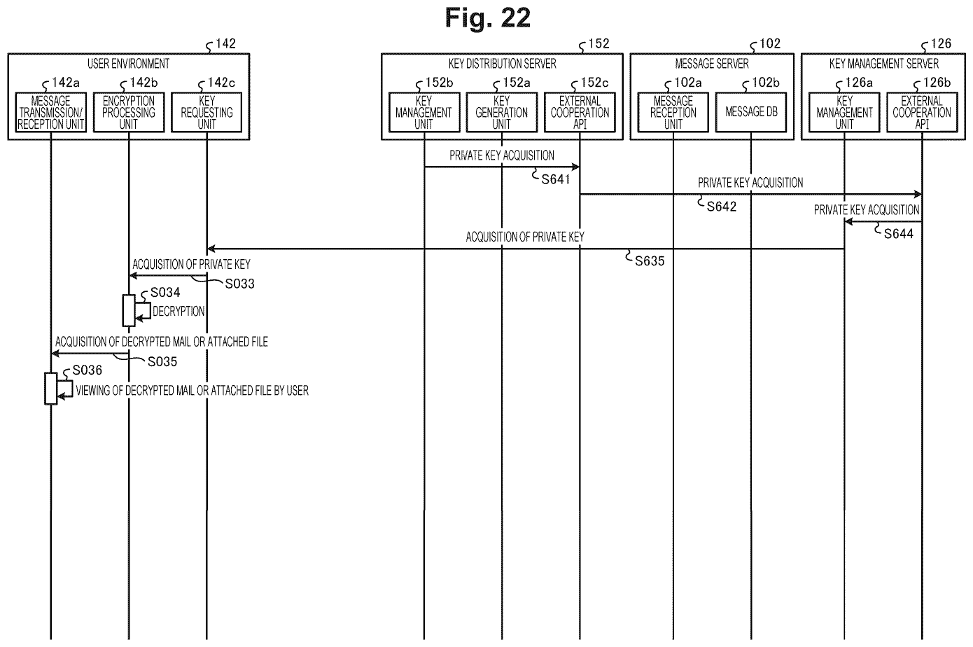

FIG. 19 is a block diagram illustrating an example configuration of a communication system according to the sixth embodiment. As illustrated in FIG. 19, the communication system according to the sixth embodiment differs from the example illustrated in FIG. 15 in that the key management server 125 is not provided in the transmission-side network 1, and a key distribution server 152 includes a key generation unit 152a that generates a private key.

[Processing Procedures in the Communication System] Next, an example of the processing procedures in a communication process to be performed by the communication system is described with reference to FIGS. 20 to 22. FIGS. 20 to 22 are sequence diagrams illustrating an example flow of processing in the communication system according to the sixth embodiment.

As illustrated in FIGS. 20 to 22, after an encryption process is performed in the user environment 131 (S000 to S008) as in FIG. 2, the message transmission unit 101c transmits the message to the message DB 102b of the message server 102 (S009).

Subsequently, the message recipient requests the message server 102 to acquire a new message, using the user environment 142 (S621). The message reception unit 102a of the message server 102 then requests the message DB 102b to search for a new message addressed to the message recipient (S622). The message DB 102b then searches for a new message addressed to the message recipient (S623), and replies with the new message to the message reception unit 102a (S624). The message reception unit 102a replies with the new message to the message transmission/reception unit 142a of the user environment 142 (S625).

The message transmission/reception unit 142a of the user environment 142 checks the presence/absence of an encrypted message or an encrypted attached file in the acquired new message (S026), and, if the new message includes an encrypted message or an encrypted attached file, requests an encryption processing unit 142b for the identifier of the message recipient used in the encryption of the encrypted message or the encrypted attached file, and for decryption of the encrypted message or the encrypted attached file (S027).

The encryption processing unit 142b of the user environment 142 requests a key requesting unit 142c for the private key necessary for decrypting the encrypted message or the encrypted attached file (S028). The key requesting unit 141c searches for the private key (S029), and, if the private key is not stored in the key storage area, requests a key management server 126 to generate the private key corresponding to the identifier (S630). The key management unit 126a of the key management server 126 requests the private key from an external cooperation API 126b (S632).

The external cooperation API 126b of the key management server 126 then requests the private key from an external cooperation API 152c of the key distribution server 152 (S634). The external cooperation API 152c of the key distribution server 152 then causes a key management unit 152b to search for the private key (S635). If the private key is not stored in its own key storage area, the key management unit 152b makes a private key generation request to the key generation unit 152a (S636). The key generation unit 152a then generates the private key (S639).

The key management unit 152b then acquires the private key from the key generation unit 152a (S640). Subsequently, the external cooperation API 152c acquires the private key from the key management unit 152b (S641). The external cooperation API 152c then replies with the private key to the external cooperation API 126b of the key management server 126 (S642). Subsequently, the key management unit 126a acquires the private key from the external cooperation API 126b (S644).

The key management unit 126a then replies with the private key to the key requesting unit 142c of the user environment 142 (S635). The encryption processing unit 142b of the user environment 142 acquires the private key from the key storage area of the key requesting unit 142c (S033), and decrypts the encrypted message or the encrypted attached file (S034).

The message transmission/reception unit 142a of the user environment 142 then acquires the decrypted message or the decrypted attached file from the encryption processing unit 142b (S035), and causes the message recipient to view the decrypted message or the decrypted attached file (S036).

[System Configuration and the Like] Further, each of the components of each of the devices illustrated in the drawings is functionally conceptual, and is not required to be physically designed as illustrated. That is, specific modes of distribution and integration of devices are not limited to those illustrated in the drawings, and all or some of the devices can be functionally or physically distributed and integrated in any appropriate unit in accordance with various loads, usage conditions, and the like. Although the description of the above embodiments concerns cases where the occurrence of an event on an operation screen displayed on an operation log acquisition device is detected, and an operation log is recorded, the present invention is not limited these cases. For example, the operation log acquisition device may detect an event on an operation screen displayed on another terminal, and record an operation log. Further, all or some of the processing functions executed in the respective devices can be implemented by a CPU and a program to be analyzed and executed by the CPU, or can be implemented as hardware by wired logic.

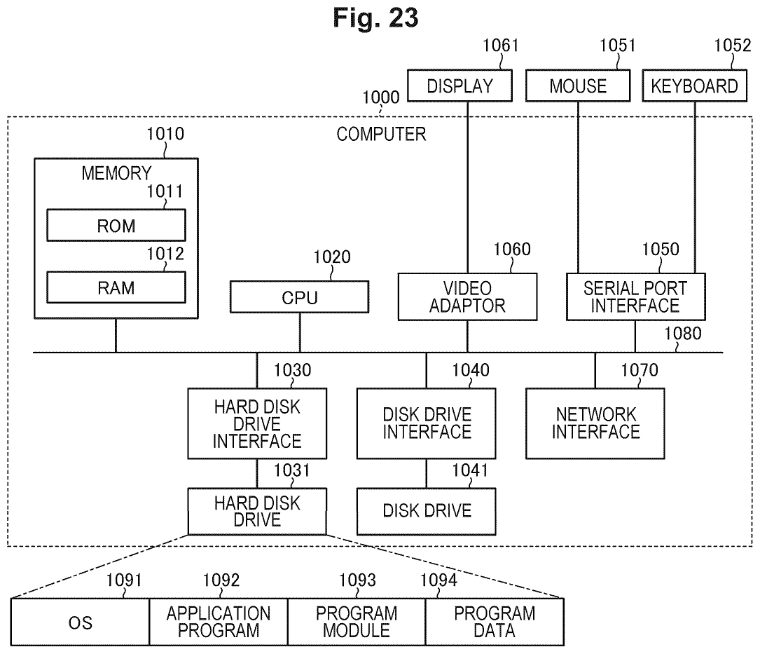

Also, among the individual processes described in these embodiments, all or some of the processes described as being performed automatically can be performed manually, or all or some of the processes described as being performed manually can be performed automatically by a known method. In addition to the above, the processing procedures, the control procedures, the specific names, and the information including various kinds of data and parameters that are illustrated in the above literatures and drawings can be changed as appropriate, unless otherwise specified.

[Program] FIG. 23 is a diagram illustrating a computer that executes a communication program. A computer 1000 includes a memory 1010 and a CPU 1020, for example. The computer 1000 also includes a hard disk drive interface 1030, a disk drive interface 1040, a serial port interface 1050, a video adapter 1060, and a network interface 1070. These components are connected by a bus 1080.

The memory 1010 includes a ROM 1011 and a RAM 1012. The ROM 1011 stores a boot program such as a basic input output system (BIOS), for example. The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. The serial port interface 1050 is connected to a mouse 1051 and a keyboard 1052, for example. The video adapter 1060 is connected to a display 1061, for example.

The hard disk drive 1031 stores an operating system (OS) 1091, an application program 1092, a program module 1093, and program data 1094, for example. That is, the program that defines the respective processes to be performed by the respective devices is implemented as the program module 1093 in which codes that can be executed by the computer 1000 are written. The program module 1093 is stored in the hard disk drive 1031, for example. The program module 1093 for performed the same processes as in the functional configuration in a user terminal is stored in the hard disk drive 1031, for example. Note that the hard disk drive 1031 may be replaced with a solid state drive (SSD).

Also, the setting data that is used in the processes according to the above embodiments is stored as the program data 1094 in the memory 1010 or the hard disk drive 1031, for example. The CPU 1020 then reads the program module 1093 and the program data 1094 stored in the memory 1010 or the hard disk drive 1031 into the RAM 1012 as necessary, to execute them.

Note that the program module 1093 and the program data 1094 are not necessarily stored in the hard disk drive 1031, but may be stored in a removable storage medium and be read by the CPU 1020 via the disk drive 1041 or the like, for example. Alternatively, the program module 1093 and the program data 1094 may be stored in another computer connected via a network (a local area network (LAN), a wide area network (WAN), or the like). The program module 1093 and the program data 1094 may be read from another computer by the CPU 1020 via the network interface 1070.

While the embodiments to which the invention made by the present inventors is applied have been described above, the present invention is not limited by the description and the drawings constituting part of the disclosure of the above embodiments according to the present invention. That is, other embodiments, examples, operation techniques, and the like made by those skilled in the art and the like on the basis of the above embodiments are all included in the scope of the present invention.

### REFERENCE SIGNS LIST

1 network
101 message server
101a message reception unit
101b message DB
101c message transmission unit
111 directory server
111a attribute management unit
121 key management server
121a key issuance unit
121b key management unit
131, 141 user environment
131a, 141a message transmission/reception unit
131b, 141b encryption processing unit
131c, 141c key requesting unit
1310, 1410 encryption unit
1311, 1411 decryption unit

1. A communication system comprising: a user terminal that transmits and receives a message; and a server device that manages a public key and a private key, wherein
the user terminal includes:
first processing circuitry configured to:
when transmitting the message to another user terminal, acquire a public key corresponding to identification information about a recipient of the message, and encrypt the message or a file attached to the message, using the acquired public key;
transmit, to the another user terminal, the message encrypted or the file attached to the message;
when receiving the message from the another user terminal, request the server device to provide a private key for decrypting the message or the file attached to the message, and receive the private key from the server device; and
decrypt the message or the file attached to the message, using the private key received, and
the server device includes
second processing circuitry configured to:
when accepting a request for the private key from the user terminal, generate the private key corresponding to the identification information about the recipient of the message, and transmit the private key to the user terminal.

2. The communication system according to claim 1, wherein the first processing circuitry is further configured to encrypt the message or the file attached to the message, with policy information included in the message or the file, the policy information indicating a condition for allowing decryption.

3. A user terminal comprising:
processing circuitry configured to:
when transmitting a message to another user terminal, acquire a public key corresponding to identification information about a recipient of the message, and encrypt the message or a file attached to the message, using the acquired public key;
transmit, to the another user terminal, the message encrypted or the file attached to the message;
when receiving the message from the another user terminal, request a server device to provide a private key for decrypting the message or the file attached to the message, and receive the private key from the server device; and
decrypt the message or the file attached to the message, using the private key received.

4. A communication method implemented by a communication system that includes: a user terminal that transmits and receives a message; and a server device that manages a public key and a private key,
the communication method comprising:
by the user terminal, when transmitting the message to another user terminal, acquiring a public key corresponding to identification information about a recipient of the message, and encrypting the message or a file attached to the message, using the acquired public key;
by the user terminal, to transmitting, to the another user terminal, the message encrypted or the file attached to the message;
by the user terminal, when receiving the message from the another user terminal, requesting the server device to provide a private key for decrypting the message or the file attached to the message, and receiving the private key from the server device;
by the server device, when accepting a request for the private key from the user terminal, generating the private key corresponding to the identification information about the recipient of the message, and transmitting the private key to the user terminal; and
by the user terminal, decrypting the message or the file attached to the message, using the private key received.

5. (canceled)
